(19) United States
(12) Patent Application Publication
(10) Pub. No.: US 2008/0005014 A1
(43) Pub. Date: Jan. 3, 2008

(54) System and method for providing property-secured credit card products

(76) Inventor: Steven W. Smith, Dallas, TX (US)

Correspondence Address: STEVEN W. SMITH, 7237 BIRCHWOOD DRIVE, DALLAS, TX, 75240, US

(21) Appl. No.: 11/480,593

(22) Filed: Jul. 3, 2006

(51) Int. Cl. G06Q 40/00

(52) U.S. Cl. 705/38

(57) ABSTRACT

A system, method, and computer program product provides credit card products secured with personal property, real property, or intellectual property to minimize risk to credit card issuers while making secured credit card products available to customers who currently cannot obtain such a card. The customer identifies customer property to be utilized as collateral in exchange for the secured credit card product. A market value of the collateral property is assessed, and the card issuer determines a credit limit based on the assessed market value. The card issuer offers the secured credit card product with the determined credit limit, and receives in response, an assignment of ownership of the customer's collateral property. The card issuer provides the secured credit card product in response to receiving the assignment of ownership. The assignment and the property may be held by an escrow agent.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

This invention is related to credit card products and to systems and methods for providing such products. More particularly, and not by way of limitation, the invention provides a system and method that minimizes risk to credit card issuers, and makes secured credit card products available to people who currently cannot obtain such a card, by providing credit card products secured with personal property, real property, or intellectual property.

The use of credit card products has become so universal that it has fundamentally changed the manner in which financial transactions and dealings are viewed and conducted in society today. Credit card issuers such as banks and other financial institutions most commonly utilize plastic card-like members to represent credit card products. With a credit card, an authorized customer or cardholder is capable of purchasing services and/or merchandise without an immediate, direct exchange of cash. With each purchase, the cardholder incurs debt, which the cardholder may thereafter pay upon receipt of a periodic statement. In most cases, the cardholder has the option to either fully pay the outstanding balance or defer a portion of the balance for later payment with accompanying interest or finance charges for the period during which payment of the outstanding debt is deferred.

The total amount of funds available to the cardholder at any particular time for making purchases is typically limited to a particular amount predetermined by the issuer of the card. This amount is commonly referred to as the “credit limit” of the credit card. The size of the issuer-imposed credit limit is generally based on a number of non-exclusive factors, the most important of which are often the cardholder's earning capacity and the cardholder's credit history. When purchases are made or debts incurred with the credit card, the available portion of the credit limit is reduced by the purchase or debt amounts. In addition, finance charges, when incurred, are also subtracted from the available portion of the credit limit.

Credit cards are typically structured according to one of two general varieties: unsecured or secured. Of these two varieties, unsecured credit cards are perhaps the most common type of credit card product. Unsecured credit cards are aimed at customers with excellent or good credit history, and are distinct from secured credit cards in that they do not require a monetary security deposit from the cardholder. The issuer of an unsecured credit card may offer potential customers a particular unsecured credit card by disclosing the terms and conditions of the credit card product (e.g., annual fees, interest rate(s) and finance charges, etc.) and the credit limit of the credit card, which may reach a stated maximum upon qualification. When a customer returns a credit card application, the issuer generally determines the credit limit based on various factors, such as the customer's credit history and earning capacity.

Secured credit cards are an alternative to unsecured credit cards and are designed for customers with poor or bad credit history. Secured credit cards differ from unsecured credit cards in that they require a security deposit from the customer before a credit card account can be established. There are generally two types of secured credit card products: ratio products and fixed-line products. Ratio products are credit cards that are offered to potential customers with a variable credit limit, which is based on an indicated ratio or multiple of a security deposit to be provided by the customer. In response to an offer from the credit card issuer, the customer may choose a security deposit ranging between a stated minimum and maximum amount to obtain a desired credit limit.

In contrast, fixed-line products are secured credit cards that are offered to potential customers with a fixed credit limit and a predetermined security deposit amount. An offer for a fixed-line product may indicate both the required security deposit amount and the fixed credit limit. Since the issuer of a fixed-line product does not vary the credit limit for potential customers, the customer can only receive the indicated credit limit in exchange for providing the security deposit.

Although secured credit cards have enabled credit card issuers to provide credit card products to individuals with poor credit, these types of credit card products suffer from several drawbacks. For example, the main disadvantage of ratio products is that certain customers may seek the maximum credit limit by providing a larger security deposit, but still default on their payments. As a result, a credit card issuer may be exposed to unsatisfactory levels of financial risk. While such risk can be minimized by providing fixed-line products, offers for fixed-line secured credit card products typically do not receive a good level of response, since the fixed credit limit is normally lower and/or determined based on the entire group of potential customers that receive the offers from the issuer. This results in a fixed credit limit being offered to certain individuals that could potentially qualify for a higher credit limit. Additionally, many lower-income people do not have disposable cash to put up as a security deposit. For these people, secured credit cards, as they currently exist, are not available.

In view of the foregoing, there is presently a need for an improved system and method for offering and providing secured credit card products. For example, a need exists for a secured credit card product that minimizes the risk to credit card issuers while attracting a larger number of potential customers having a poor or bad credit history. There is also a need for an improved system and method for offering secured credit cards to people who do not have cash available for a security deposit. The present invention provides such a system and method.

### BRIEF SUMMARY OF THE INVENTION

The present invention provides a system, method, and computer program product that minimizes risk to credit card issuers, and makes secured credit card products available to people who currently cannot obtain such a card. The present invention provides credit card products secured with personal property, real property, or intellectual property.

Thus in one aspect, the present invention is directed to a method of providing a secured credit card product from a card issuer to a customer. The method includes identifying customer property to be utilized as collateral in exchange for the secured credit card product; and providing the customer with the secured credit card product having a credit limit based on an assessed market value of the customer's collateral property.

In another aspect, the present invention is directed to a method of providing a secured credit card product from a card issuer to a customer. The method includes receiving from the customer, an identification of customer property to be utilized as collateral in exchange for the secured credit card product; assessing a market value of the customer's collateral property; and determining by the card issuer, a credit limit based on the assessed market value of the customer's collateral property. The method also includes offering by the card issuer, the secured credit card product with the determined credit limit; receiving from the customer, an assignment of ownership of the customer's collateral property to the card issuer; and issuing by the card issuer, the secured credit card product in response to receiving the assignment of ownership. The card issuer may periodically reassess the market value of the customer's collateral property, and periodically determine a revised credit limit based on the reassessed market value of the customer's collateral property.

In another aspect, the present invention is directed to a computer program product for providing a secured credit card product from a card issuer to a customer. The computer program product includes computer-readable media having computer-readable code for effecting actions in a computing platform. The computer program product comprises program code for determining by the card issuer, a credit limit for the secured credit card product based on an assessed market value of collateral property assigned to the card issuer by the customer; and program code for providing the secured credit card product to the customer with the determined credit limit.

In another aspect, the present invention is directed to a system for providing a secured credit card product from a card issuer to a customer. The system includes means for receiving from the customer, an identification of customer property to be utilized as collateral in exchange for the secured credit card product; and means for providing the customer with the secured credit card product having a credit limit based on an assessed market value of the customer's collateral property.

### BRIEF DESCRIPTION OF THE SEVERAL VIEWS OF THE DRAWING

In the following, the essential features of the invention will be described in detail by showing preferred embodiments, with reference to the attached figures in which:

FIG. 1 is a flow chart illustrating the steps of an exemplary embodiment of the method of the present invention;

FIG. 2 is a simplified block diagram of an exemplary network arrangement for identifying high-risk customers suitable for utilizing the present invention;

FIG. 3 is a simplified block diagram of an exemplary embodiment of the system of the present invention; and

FIG. 4 is a signaling diagram illustrating the flow of messages and information between the various components of the exemplary system of FIG. 3 while performing the exemplary method of the present invention.

### DETAILED DESCRIPTION OF THE INVENTION

The present invention provides a system and method that minimizes risk to credit card issuers, and makes secured credit card products available to people who currently cannot obtain such a card, by providing credit card products secured with personal property, real property, or intellectual property. The card issuer may use the property-secured credit card of the present invention as an alternative for high-risk customers who do not qualify for an unsecured credit card, and who do not have disposable cash available for a security deposit for a traditional secured credit card.

Rather than requiring a cash security deposit, the card issuer may obtain title to a customer's personal property such as the customer's motor vehicle, boat, jewelry, or other valuable property, and may hold the property as collateral for the credit issued with the secured credit card product. An escrow agent may hold the property in escrow. If the customer defaults on his payments, the escrow agent delivers the property to the card issuer. Alternatively, the escrow agent may sell the property and deliver cash to the card issuer.

The customer may also put up intellectual property such as patent, trademarks, and copyrights as collateral for the secured credit card product.

In some jurisdictions, real property may also be put up as collateral for the secured credit card product. Whether personal property, intellectual property, or real property is put up, the card issuer may utilize the services of an independent property assessor to determine the current market value of the property. The card issuer may then use this assessed value to determine an appropriate credit limit for the customer.

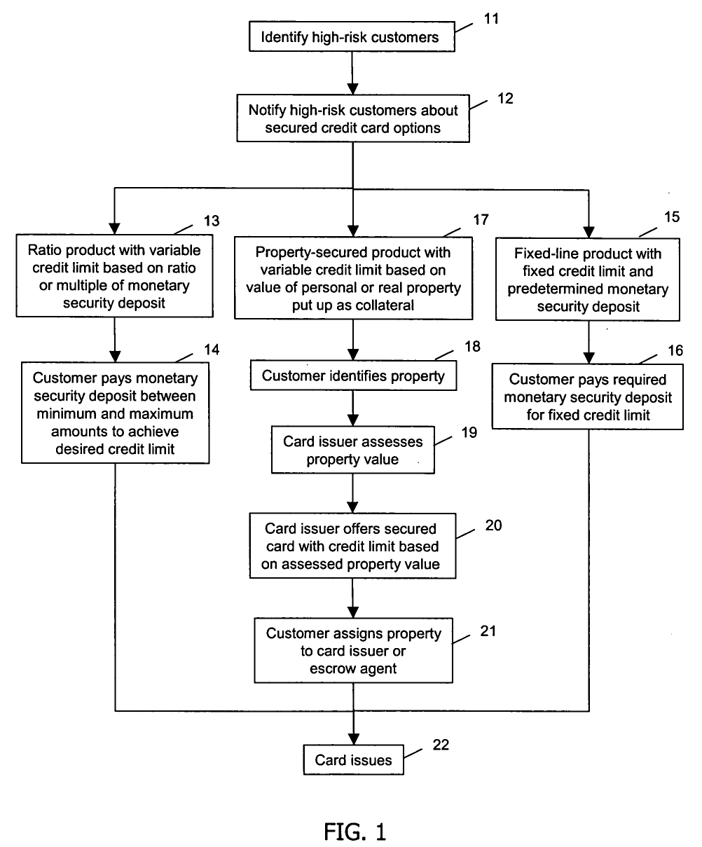

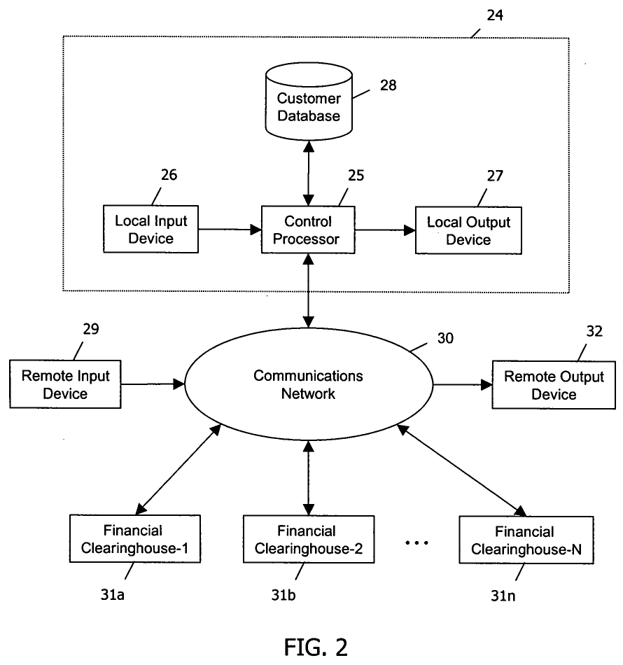

FIG. 1 is a flow chart illustrating the steps of an exemplary embodiment of the method of the present invention. At step 11, the card issuer identifies high-risk customers for whom unsecured credit cards are not appropriate. This step is described in more detail in connection with FIG. 2 below. At step 12, the card issuer notifies the high-risk customers about secured credit card options available through the card issuer. The options may include traditional secured credit card products such as ratio products and fixed-line products, together with the property-secured credit card product of the present invention. If a customer requests a ratio product, the process moves from step 12 to step 13 where the card issuer offers a ratio product having a variable credit limit based on a ratio or multiple of a monetary security deposit. The security deposit typically falls in a range between a minimum amount and a maximum amount. At step 14, the customer pays the monetary security deposit as selected between the minimum and maximum amounts to achieve a desired credit limit. The process then moves to step 22 where the card issuer issues the secured credit card.

If the customer requests a fixed-line product, the process moves from step 12 to step 15 where the card issuer offers a fixed-line product having a fixed credit limit and a predetermined monetary security deposit. At step 16, the customer pays the required monetary security deposit for the fixed credit limit. The process then moves to step 22 where the card issuer issues the secured credit card.

If the customer requests a property-secured product, the process moves from step 12 to step 17 where the card issuer offers a property-secured product having a variable credit limit based on the value of personal property, real property, or intellectual property that the customer puts up as collateral. At step 18, the customer identifies the property he wishes to put up as collateral. At step 19, the card issuer assesses the property value. At step 20, the card issuer offers a secured credit card having a credit limit based on the assessed property value. At step 21, the customer assigns the property to the card issuer or to an escrow agent. The process then moves to step 22 where the card issuer issues the secured credit card.

FIG. 2 is a simplified block diagram of an exemplary network arrangement for identifying high-risk customers suitable for utilizing the present invention. The facility of a card issuer 24 may include a control processor 25, a local input device 26, a local output device 27, and a customer database 28. Personnel in the local facility may input customer information through the local input device. Personnel located at remote facilities may input customer information through a remote input device 29 connected to the control processor through a communications network 30. Additional customer information may be obtained from financial clearinghouses 31a-31n. This information may include credit history information obtained from the major credit bureaus such as Experian, Equifax, and TransUnion. The control processor 25 compares the input information with predefined criteria to determine a level of risk associated with each customer. The various criteria may be printed out for management review using the local output device 27 or a remote output device 32. The output devices may also print out a list of potential customers suitable for each secured credit card type, each customer's credit or risk rating, and/or a potential profitability level associated with each potential customer. The results of the analysis may then be stored in the customer database 28.

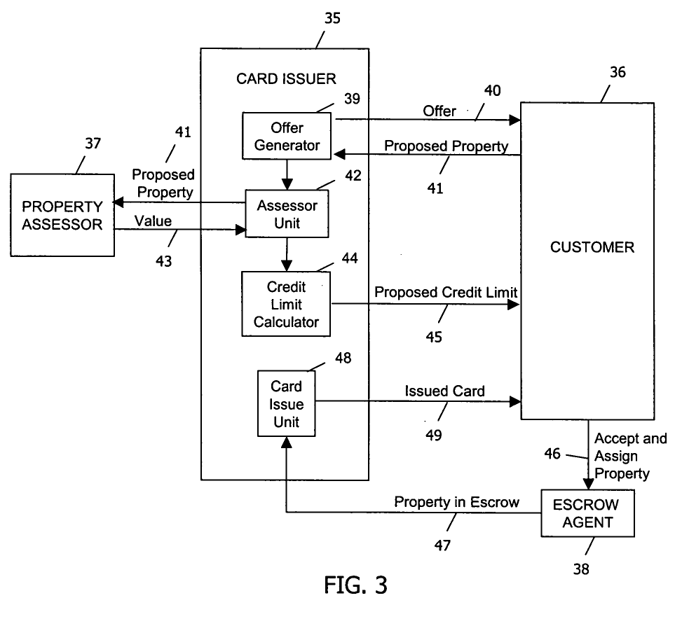

FIG. 3 is a simplified block diagram of an exemplary embodiment of the system of the present invention. The system may be implemented with a card issuer 35 interfacing with a customer 36. In the illustrated example, an optional property assessor 37 and an optional escrow agent 38 are also shown. After compiling a list of potential customers, as described in connection with FIG. 2, an offer generator 39 generates and sends an offer 40 to the customer for a property-secured credit card. If the customer accepts the offer, the customer responds by identifying proposed collateral property 41 to the card issuer. An assessor unit 42 assesses the market value of the proposed property. This may be done internally by the card issuer or, alternatively, the proposed property 41 may be identified to the optional property assessor 37. In this case, the property assessor assesses the fair market value of the proposed property and returns the market value 43 to the card issuer.

A credit limit calculator 44 then determines a proposed credit limit 45 and sends the proposed credit limit to the customer 36. The credit limit may be equal to the market value of the proposed property, a multiple of the market value, or a fraction of the market value. Periodically, the card issuer may reassess the market value of the proposed property, or have the property assessor reassess the market value, and then readjust the credit limit accordingly.

If the customer 36 accepts the proposed credit limit 45, the customer assigns ownership of the proposed property to the card issuer 35. The card issuer may create standard assignment documents for different types of property. The assignment document may be, for example a deed, a title, an assignment agreement, or other legally binding agreement transferring ownership to the card issuer. The assignment document may be supplied to the customer at the same time the customer is informed of the proposed credit limit 45, or at another suitable time. In the illustrated example, the customer accepts the proposed credit limit and at 46, executes the assignment document to assign the proposed property to the card issuer. The executed assignment document, and in some cases the property itself, is then held in escrow by the optional escrow agent 38.

At 47, the escrow agent informs the card issuer 35 that the properly executed assignment document and the property, when applicable, has been delivered to the escrow agent. In response, a card issue unit 48 then issues the property-secured credit card, which is provided to the customer at 49.

Depending on the nature of the property, either the properly executed assignment document, or the property and the assignment document together, are delivered to the optional escrow agent 38. For example, if the property is an automobile, the customer most likely needs the automobile for his livelihood. Therefore, only the executed assignment document or automobile title is delivered to the escrow agent. For other types of property such as jewelry or other valuable personal items, the property itself together with the executed assignment document may be delivered to the escrow agent. The escrow agent holds the property in escrow for the duration of the agreement between the card issuer and the customer. If the customer performs as agreed and makes all required payments under the terms of the credit card agreement, the escrow agent returns the assignment document and the property, if held, to the customer when the credit card agreement terminates. If the customer defaults on his payments, the escrow agent delivers the assignment document and the property, if held, to the card issuer. The card issuer may sell the property, if held, or repossess and sell the property if the property itself is not held in escrow.

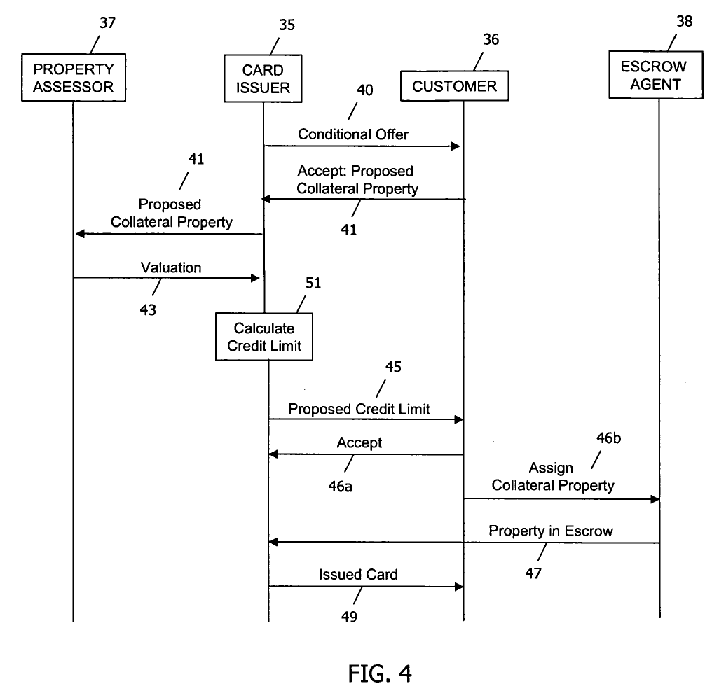

FIG. 4 is a signaling diagram illustrating the flow of messages and information between the various components of the exemplary system of FIG. 3 while performing the exemplary method of the present invention. At step 40, the card issuer 35 sends the conditional offer for a secured credit card product to the customer 36. At step 41, the customer accepts the offer and proposes property to be put up as collateral for the secured credit card product. The card issuer relays the proposed collateral property or a description thereof to the property assessor 37. At step 43, the property assessor returns a market valuation of the proposed collateral property to the card issuer.

At step 51, the card issuer 35 calculates a proposed credit limit. The credit limit may be equal to the market value of the proposed property, a multiple of the market value, or a fraction of the market value. Periodically, the card issuer may reassess the market value of the proposed property, or have the property assessor reassess the market value, and then readjust the credit limit accordingly. At step 45, the card issuer sends the proposed credit limit to the customer 36. At step 46a, the customer notifies the card issuer that the customer has accepted the proposed credit limit. At step 46b, the customer assigns ownership of the collateral property to the card issuer and provides the property itself, a properly executed assignment document, or both to the escrow agent 38. At step 47, the escrow agent notifies the card issuer that the property is now held in escrow. In response, the card issuer issues the secured credit card product to the customer at step 49.

Many of the steps performed by the present invention may be performed by a computer program product implemented at the card issuer 35. For example, the process of identifying potential customers for the property-secured credit card product may be automated as well as the process of sending offers to the identified customers. The assessor unit 42 may be automated to access one or more databases to determine market values for particular types of customer property. Alternatively, the interface between the assessor unit and the property assessor 37 may be automated. The credit limit calculator 44 may be automated to calculate the credit limit based on a market value automatically supplied by the assessor unit. Likewise, the card issue unit 48 may be automated to automatically issue the property-secured credit card product upon receiving an indication from the escrow agent 38 that the customer's executed assignment document, and perhaps the customer's property itself, is held in escrow.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates any all modifications that fall within the scope of the invention defined by the following claims.

What is claimed is:

1. A method of providing a secured credit card product from a card issuer to a customer, said method comprising:
identifying customer property to be utilized as collateral in exchange for the secured credit card product; and
providing the customer with the secured credit card product, said secured credit card product having a credit limit based on an assessed market value of the customer's collateral property.

2. The method according to claim 1, wherein the step of identifying customer property includes receiving from the customer, an identification of property to be utilized as collateral in exchange for the secured credit card product, said property being selected from a group consisting of personal property, real property, and intellectual property.

3. The method according to claim 2, further comprising, prior to providing the customer with the secured credit card product, the steps of:
assessing the market value of the customer's collateral property;
determining by the card issuer, the credit limit based on the assessed market value of the customer's collateral property;
offering by the card issuer, the secured credit card product with the determined credit limit; and
receiving from the customer, an assignment to the card issuer of ownership of the customer's collateral property.

4. The method according to claim 3, wherein the market value is assessed by the card issuer or a property assessor who informs the card issuer of the assessed market value.

5. The method according to claim 4, wherein the step of determining the credit limit includes determining the credit limit from a group consisting of:
a credit limit equal to the assessed market value of the customer's collateral property;
a credit limit equal to a multiple of the assessed market value of the customer's collateral property; and
a credit limit equal to a fraction of the assessed market value of the customer's collateral property.

6. The method according to claim 5, wherein the step of receiving an assignment of ownership also includes receiving the customer's collateral property from the customer.

7. The method according to claim 5, wherein the step of receiving an assignment of ownership includes receiving by an escrow agent, an assignment document executed by the customer, wherein the escrow agent notifies the card issuer that the executed assignment document is held in escrow.

8. A method of providing a secured credit card product from a card issuer to a customer, said method comprising:
receiving from the customer, an identification of customer property to be utilized as collateral in exchange for the secured credit card product;
assessing a market value of the customer's collateral property;
determining by the card issuer, a credit limit based on the assessed market value of the customer's collateral property;
offering by the card issuer, the secured credit card product with the determined credit limit;
receiving from the customer, an assignment to the card issuer of ownership of the customer's collateral property; and
issuing by the card issuer, the secured credit card product in response to receiving the assignment of ownership.

9. The method according to claim 8, further comprising:
periodically reassessing the market value of the customer's collateral property; and
periodically determining by the card issuer, a revised credit limit based on the reassessed market value of the customer's collateral property;

10. A computer program product for providing a secured credit card product from a card issuer to a customer, the computer program product comprising computer-readable media having computer-readable code, the computer program product comprising the following computer-readable program code for effecting actions in a computing platform:
program code for determining-by-the card issuer, a credit limit for the secured credit card product based on an assessed market value of collateral property assigned to the card issuer by the customer; and
program code for providing to the customer, the secured credit card product with the determined credit limit.

11. The computer program product according to claim 10, further comprising:
program code for receiving from the customer, an identification of customer property to be utilized as the collateral property; and
program code for assessing a market value of the customer's collateral property.

12. The computer program product according to claim 11, wherein the program code for assessing a market value includes program code for interfacing between the card issuer and a property assessor.

13. The computer program product according to claim 11, wherein the program code for determining a credit limit determines the credit limit from a group consisting of:
a credit limit equal to the assessed market value of the customer's collateral property;
a credit limit equal to a multiple of the assessed market value of the customer's collateral property; and
a credit limit equal to a fraction of the assessed market value of the customer's collateral property.

14. The computer program product according to claim 11, further comprising program code for receiving from the customer, an assignment to the card issuer of ownership of the customer's collateral property;
wherein the program code for providing the secured credit card product to the customer provides the secured credit card product in response to an indication from the program code for receiving the assignment, that the assignment of ownership has been received.

15. The computer program product according to claim 14, wherein the program code for receiving an assignment includes program code for interfacing between the card issuer and an escrow agent that receives the assignment from the customer.

16. The computer program product according to claim 10, further comprising:
program code for identifying customers suitable for the secured credit card product; and
program code for sending offers for the secured credit card product to the identified suitable customers.

17. A system for providing a secured credit card product from a card issuer to a customer, said system comprising:
means for receiving from the customer, an identification of customer property to be utilized as collateral in exchange for the secured credit card product; and
means for providing the customer with the secured credit card product, said secured credit card product having a credit limit based on an assessed market value of the customer's collateral property.

18. The system according to claim 17, wherein the customer's collateral property is selected from personal property, real property, and intellectual property.

19. The system according to claim 18, further comprising:
means for assessing the market value of the customer's collateral property;
means for determining by the card issuer, the credit limit based on the assessed market value of the customer's collateral property;
means for offering by the card issuer, the secured credit card product with the determined credit limit; and
means for receiving from the customer, an assignment to the card issuer of ownership of the customer's collateral property.

20. The system according to claim 19, wherein the means for determining the credit limit determines the credit limit from a group consisting of:
a credit limit equal to the assessed market value of the customer's collateral property;
a credit limit equal to a multiple of the assessed market value of the customer's collateral property; and
a credit limit equal to a fraction of the assessed market value of the customer's collateral property.

21. The system according to claim 20, wherein the means for receiving an assignment of ownership includes an interface between the card issuer and an escrow agent that receives from the customer, an assignment document executed by the customer, wherein the escrow agent notifies the card issuer via the interface that the executed assignment document is held in escrow.
